(19) United States
(12) Patent Application Publication
(10) Pub. No.: US 2020/0153579 A1
(43) Pub. Date: May 14, 2020

(54) Enhancement Of Sounding Reference Signal In Mobile Communications

(71) Applicant: MediaTek Inc., Hsinchu City (TW)

(72) Inventors: Gilles Charbit, Cambridge (GB); Kuhn-Chang Lin, Hsinchu City (TW)

(21) Appl. No.: 16/677,641

(22) Filed: Nov. 7, 2019

Related U.S. Application Data
(60) Provisional application No. 62/757,788, filed on Nov. 9, 2018.

(51) Int. Cl. H04L 5/00; H04W 72/04

(52) U.S. Cl. CPC H04L 5/0048; H04L 5/0007; H04W 72/044; H04W 72/042

(57) ABSTRACT

Various examples and schemes pertaining to enhancement of sounding reference signal (SRS) in mobile communications are described. An apparatus determines to activate one from an SRS configuration set that includes an SRS configuration and at least one enhanced SRS configuration. The apparatus then transmits an SRS to a network node of a wireless network based on activated one from the SRS configuration set.

### CROSS REFERENCE TO RELATED PATENT APPLICATION(S)

The present disclosure is part of a non-provisional application claiming the priority benefit of U.S. Patent Application No. 62/757,788, filed on 9 Nov. 2018, the content of which being incorporated by reference in its entirety.

### TECHNICAL FIELD

The present disclosure is generally related to mobile communications and, more particularly, to techniques pertaining to enhancement of sounding reference signal (SRS) in mobile communications.

### BACKGROUND

Unless otherwise indicated herein, approaches described in this section are not prior art to the claims listed below and are not admitted as prior art by inclusion in this section.

In the current Evolved-Universal Mobile Telecommunications Service (UMTS) Terrestrial Radio Access Network (E-UTRAN) specifications, only the last single-carrier frequency-division multiple access (SC-FDMA) symbol in the second slot of a subframe may be allocated for SRS in a subset of subframes where SRS is configured. There is no collision between the SRS and physical uplink control channel (PUCCH) or physical uplink shared channel (PUSCH). For legacy SRS, this is not an issue since, if a network node (e.g., eNB) cannot avoid SRS transmission in subframes not used for PUCCH format 1, 1a and 1b, then shortened PUCCH can be used. There is no impact on PUCCH performance as shortened PUCCH uses its own orthogonal sequences (e.g., no truncation for format 1, 1a and 1b). Shortened PUCCH can also be used for PUCCH format 4 and format 5 with truncation, and there is no shortened PUCCH for format 2 and format 3. In case of additional SRS symbols, shortened PUCCH cannot be used. Truncating PUCCH to avoid collision with the uplink (UL) channels will have serious impact on PUCCH detection performance and should be avoided.

For a user equipment (UE) at a cell edge, due to UL power limitation, the SRS quality received at the network node (e.g., eNB) is likely to be poor. The more SC-FDMA symbols allocated for the UE, the more signal energy can be collected at the eNB. Therefore, allocating more SC-FDMA symbols, referred to as “enhanced SRS” herein, can be used to enhance SRS UL coverage. However, enhanced SRS tends to introduce the issue of collision with other legacy UL channel(s) such as PUCCH and PUSCH. Moreover, depending on UE capability, it is possible that a UE cannot support frequency-division multiplexed PUCCH/PUSCH and SRS.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is propose various concepts, solutions, schemes, techniques, designs and methods to address aforementioned issues that may be with enhanced SRS. To address aforementioned issues, the present disclosure proposes various schemes pertaining to dynamic switch between enhanced SRS and SRS. Moreover, the present disclosure also proposes various schemes pertaining to avoidance of collision between enhanced SRS and legacy UL channels.

In one aspect, a method may involve a processor of an apparatus determining to activate one from an SRS configuration set comprising an SRS configuration and at least one enhanced SRS configuration. The method may further involve the process transmitting an SRS to a network node of a wireless network based on the activated one from the SRS configuration set.

In one aspect, a method may involve a processor of an apparatus receiving from a wireless network an SRS configuration set comprising an SRS configuration and at least one enhanced SRS configuration. The method may also involve the processor receiving from the wireless network a signaling triggering activation of one from the SRS configuration set. The method may further involve the processor transmitting an SRS to the wireless network based on the one from the SRS configuration set that is activated.

It is noteworthy that, although description provided herein may be in the context of certain radio access technologies, networks and network topologies such as Ethernet, the proposed concepts, schemes and any variation(s)/derivative(s) thereof may be implemented in, for and by other types of radio access technologies, networks and network topologies such as, for example and without limitation, 5th Generation (5G), New Radio (NR), Long-Term Evolution (LTE), LTE-Advanced, LTE-Advanced Pro, narrowband (NB), narrowband Internet of Things (NB-IoT), Wi-Fi and any future-developed networking and communication technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 shows an example scenario in accordance with an implementation of the present disclosure.

FIG. 3 shows an example scenario in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancement of SRS in mobile communications. According to the present disclosure, a number of possible solutions may be implemented separately or jointly. That is, although these possible solutions may be described below separately, two or more of these possible solutions may be implemented in one combination or another.

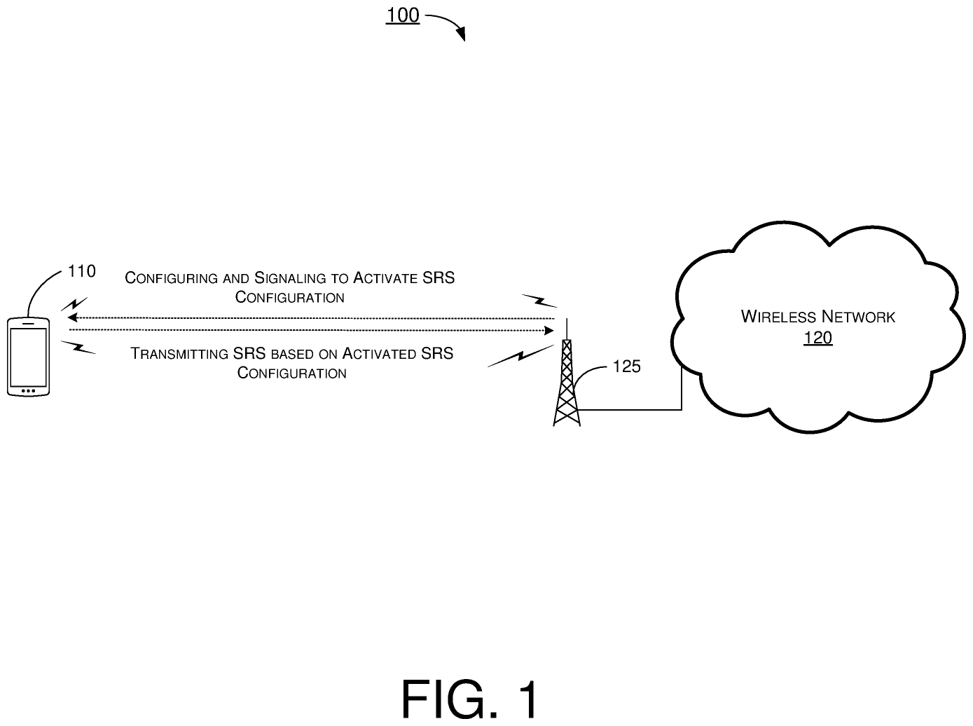

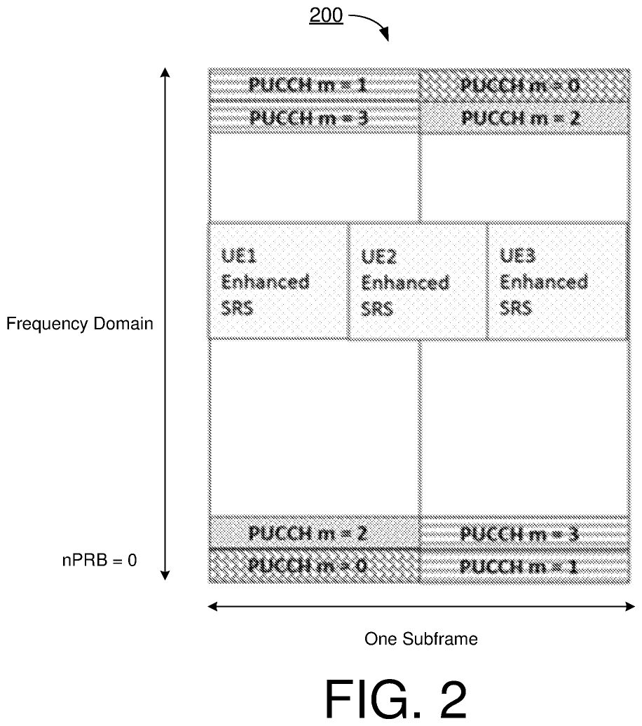

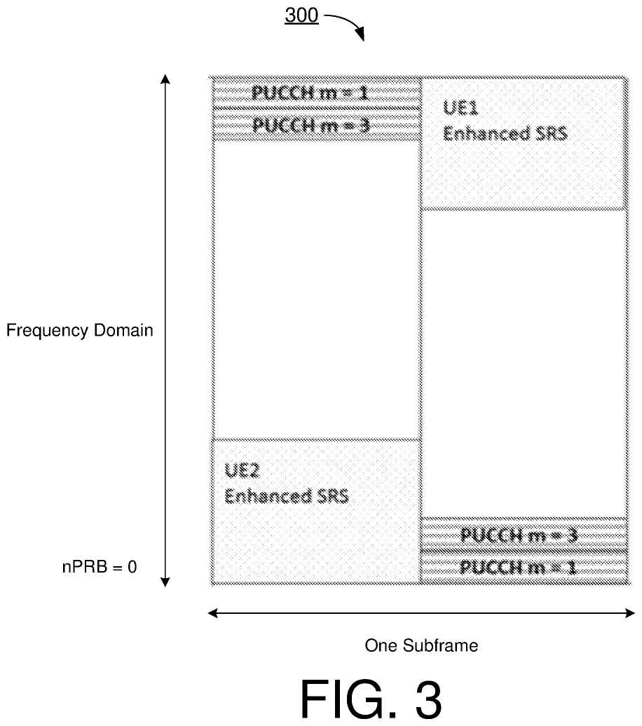

FIG. 1 illustrates an example network environment 100 in which various solutions and schemes in accordance with the present disclosure may be implemented. FIG. 2 and FIG. 3 illustrate example scenarios 200 and 300, respectively, in accordance with implementations of the present disclosure. Each of scenarios 200 and 300 may be implemented in network environment 100. The following description of various proposed schemes is provided with reference to FIG. 1-FIG. 3.

Referring to FIG. 1, network environment 100 may involve a UE 110 in wireless communication with a wireless network 120 (e.g., a 5G NR mobile network). UE 110 may initially be in wireless communication with wireless network 120 via a base station or network node 125 (e.g., an eNB, gNB or transmit-receive point (TRP)). In network environment 100, UE 110 and wireless network 120 may implement various schemes pertaining to enhancement of SRS in mobile communications in accordance with the present disclosure, as described herein.

With respect to dynamic switch between enhanced SRS and SRS, under a proposed scheme in accordance with the present disclosure, additional SRS symbols may not be mapped to edge physical resource blocks (PRBs) used for PUCCH and, additionally, no PUCCH rate matching may be needed. Under the proposed scheme, some restriction for PUCCH scheduling may be imposed for all UEs. For example, in a worst-case scenario, PUCCH capacity may become a bottleneck as there may not be sufficient PRBs not colliding with SRS that may be available to UEs in a cell. In this example, it may be reasonable to restrict that additional SRS symbols are only used for coverage enhancements for some cell-edge UEs. Considering UE mobility, a given UE may move from cell edge to an UL coverage hole. In this situation, enhanced SRS may be enabled to provide sufficient SRS quality. Therefore, an efficient way to dynamically switch between enhanced SRS and (non-enhanced or standard) SRS may be beneficial.

Under the proposed scheme, network node 125 may preconfigure one or more SRS configurations for UE 110 and then dynamically activate one of the one or more SRS configurations. In each of the one or more SRS configurations, network node 125 may configure any number of various parameters, including: a starting SC-FDMA symbol index, a number of SC-FDMA symbol(s) assigned or otherwise allocated for SRS, a periodicity of SRS, a hopping pattern, information on SRS sequence generation by higher-layer signaling, and one or more predefined rules. Under the proposed scheme, network node 125 may trigger activation of a default SRS configuration or any of the one or more preconfigured SRS configurations on UE 110. For instance, network node 125 may trigger activation of a given SRS configuration by transmitting a downlink control information (DCI) signaling, a medium access control (MAC) control element (CE), or a radio resource control (RRC) reconfiguration signaling to UE 110. Based on predefined rule(s), UE 110 may then deactivate an original SRS configuration. Moreover, under the proposed scheme, UE 110 may update the activated SRS configuration and transmit SRS based on the activated SRS configuration.

With respect to avoidance of collision between enhanced SRS and legacy UL channels, under a proposed scheme in accordance with the present disclosure, UE 110 may signal to indicate whether UE 110 supports any of a number of features/capabilities, including: frequency-division multiplexed PUCCH/PUSCH and SRS, SRS antenna (port) switching within one UL subframe, maximum number of SC-FDMA symbols for enhanced SRS, and joint support for PUCCH/PUSCH and SRS and SRS antenna (port) switching within one UL subframe. In addition to the signaling to indicate whether UE 110 supports enhanced SRS, the signaling to indicate whether UE 110 supports any combination of the above-listed features may be beneficial for UL resource management. For instance, in case that UE 110 supports SRS antenna (port) switching, derivation of the channel response may become more efficient. However, for a UE (e.g., UE 110) capable of supporting SRS antenna switching, it may be possible that UE 110 cannot simultaneously support frequency-division multiplexed PUCCH/PUSCH and SRS so that UE 110 cannot transmit PUCCH/PUSCH and SRS in the same SC-FDMA symbol(s) even when there is no collision in the frequency domain.

Under the proposed scheme, network node 125 may align configurations of SRS and PUCCH/PUSCH so that there is no collision. Referring to FIG. 2, network node 125 may reserve one or more subsets of PRBs for SRS and/or one or more subsets of PRBs for legacy UL channel(s).

Under the proposed scheme, network node 125 may restrict that some resource(s) for PUCCH/PUSCH is/are not used to be transmitted in a UL subframe in concern. Under the proposed scheme, PUCCH may be alternatingly transmitted at one of two UL cell edges on a per-slot basis. By leveraging this PUCCH signal characteristic, as shown in FIG. 3, collision may be avoided as there is no PUCCH with an even number of quantity of the m value.

Illustrative Implementations

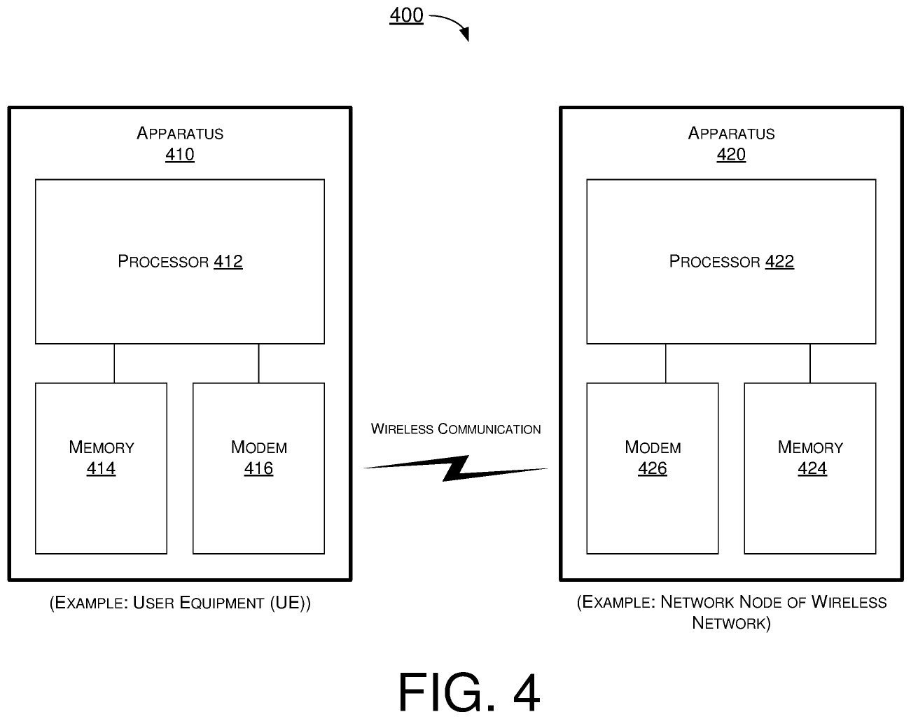

FIG. 4 illustrates an example communication system 400 having an example apparatus 410 and an example apparatus 420 in accordance with an implementation of the present disclosure. Each of apparatus 410 and apparatus 420 may perform various functions to implement schemes, techniques, processes and methods described herein pertaining to enhancement of SRS in mobile communications, including various schemes described above as well as processes described below.

Each of apparatus 410 and apparatus 420 may be a part of an electronic apparatus, which may be a UE such as a vehicle, a portable or mobile apparatus, a wearable apparatus, a wireless communication apparatus or a computing apparatus. For instance, each of apparatus 410 and apparatus 420 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 410 and apparatus 420 may also be a part of a machine type apparatus, which may be an IoT or NB-IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. Alternatively, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 410 and apparatus 420 may include at least some of those components shown in FIG. 4 such as a processor 412 and a processor 422, respectively. Each of apparatus 410 and apparatus 420 may further include one or more other components not pertinent to the proposed scheme of the present disclosure (e.g., internal power supply, display device and/or user interface device), and, thus, such component(s) of each of apparatus 410 and apparatus 420 are neither shown in FIG. 4 nor described below in the interest of simplicity and brevity.

In some implementations, at least one of apparatus 410 and apparatus 420 may be a part of an electronic apparatus, which may be a vehicle, a roadside unit (RSU), network node or base station (e.g., eNB, gNB or TRP), a small cell, a router or a gateway. For instance, at least one of apparatus 410 and apparatus 420 may be implemented in a vehicle in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 410 and apparatus 420 may be implemented in the form of one or more IC chips such as, for example and without limitation, one or more single-core processors, one or more multi-core processors, or one or more CISC or RISC processors.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including enhancement of SRS in mobile communications in accordance with various implementations of the present disclosure.

In some implementations, apparatus 410 may also include a wireless transceiver 416 coupled to processor 412 and capable of wirelessly transmitting and receiving data over a wireless link (e.g., a 3GPP connection or a non-3GPP connection). In some implementations, apparatus 410 may further include a memory 414 coupled to processor 412 and capable of being accessed by processor 412 and storing data therein. In some implementations, apparatus 420 may also include a wireless transceiver 426 coupled to processor 422 and capable of wirelessly transmitting and receiving data over a wireless link (e.g., a 3GPP connection or a non-3GPP connection). In some implementations, apparatus 420 may further include a memory 424 coupled to processor 422 and capable of being accessed by processor 422 and storing data therein. Accordingly, apparatus 410 and apparatus 420 may wirelessly communicate with each other via transceiver 416 and transceiver 426, respectively.

To aid better understanding, the following description of the operations, functionalities and capabilities of each of apparatus 410 and apparatus 420 is provided in the context of an NR communication environment in which apparatus 410 is implemented in or as a wireless communication device, a communication apparatus, a UE or an IoT device (e.g., UE 110) and apparatus 420 is implemented in or as a base station or network node (e.g., network node 125).

In one aspect of enhancement of SRS in mobile communications in accordance with the present disclosure, processor 412 of apparatus 410 may determine determining to activate one from an SRS configuration set that comprises an SRS configuration and at least one enhanced SRS configuration. Moreover, processor 412 may transmit, via transceiver 416, an SRS to apparatus 420 as a network node (e.g., network node 125) of a wireless network (e.g., wireless network 120) based on the activated one from the SRS configuration set.

In some implementations, the SRS configuration set may further include an updated configuration for an UL channel to apparatus 410. In some implementations, the at least one enhanced SRS configuration may include one or more of the following: (i) information related to a starting SC-FDMA symbol index in an UL subframe for the SRS; (ii) information related to a number of one or more SC-FDMA symbols in the UL subframe for the SRS; (iii) information related to an SRS periodicity; (iv) information related to an SRS offset; (v) information related to an SRS hopping pattern; and (vi) information related to generation of an SRS sequence.

In some implementations, processor 412 may also receive, via transceiver 416, an RRC signaling from apparatus 420 that configures the SRS configuration prior to the determining, the activating and the transmitting.

In some implementations, processor 412 may update one or more configurations for one or more UL channels to generate the updated configuration.

In some implementations, in updating the one or more configurations, processor 412 may update the one or more configurations to reserve one or more subsets of PRBs for the SRS, one or more subsets of PRBs for one or more legacy UL channels, or a combination thereof. Alternatively, or additionally, in updating the one or more configurations, processor 412 may update the one or more configurations to restrict one or more PUCCH resources or one or more PUSCH resources from being used for one or more legacy UL channels.

In some implementations, processor 412 may perform additional operations. For instance, processor 412 may receive a layer 1 (L1) signaling from the network node and, in response to receiving the L1 signaling, processor 412 may activate the one from the SRS configuration set. Alternatively, processor 412 may perform additional operations. For instance, processor 412 may receive a MAC CE from the network node and, in response to receiving the MAC CE, processor 412 may activate the one from the SRS configuration set. Alternatively, processor 412 may activate the one from the SRS configuration set based on a predefined rule.

In some implementations, the predefined rule may include activating a default SRS configuration at a beginning of configuring of the SRS configuration set comprising at least one SRS configuration and at least one enhanced SRS configuration. In some implementations, the predefined rule may include activating a new or default SRS configuration after expiry of a timer. Alternatively, or additionally, the predefined rule may include deactivating a current SRS configuration after expiry of a timer. Alternatively, or additionally, the predefined rule may include activating a new or default SRS configuration and deactivating a current SRS configuration.

In one aspect of enhancement of SRS in mobile communications in accordance with the present disclosure, processor 412 of apparatus 410 may receive, via transceiver 416, from a wireless network (e.g., wireless network 120) via apparatus 420 as a network node (e.g., network node 125) an SRS configuration set comprising an SRS configuration and at least one enhanced SRS configuration. Moreover, processor 412 may receive, via transceiver 416, from the wireless network a signaling triggering activation of one from the SRS configuration set. Furthermore, processor 412 may transmit, via transceiver 416, an SRS to the wireless network based on the one from the SRS configuration set that is activated.

In some implementations, each of the at least one enhanced SRS configuration may include one or more of the following: (i) information related to a starting SC-FDMA symbol index in an UL subframe for the SRS; (ii) information related to a number of one or more SC-FDMA symbols in the UL subframe for the SRS; (iii) information related to an SRS periodicity; (iv) information related to an SRS offset; (v) information related to an SRS hopping pattern; and (vi) information related to generation of an SRS sequence.

In some implementations, in receiving the signaling, processor 412 may receive a DCI signaling, a MAC CE, or an RRC reconfiguration signaling.

In some implementations, processor 412 may perform additional operations. For instance, processor 412 may update one or more of the plurality of configurations for one or more UL channels to generate the updated configuration. In some implementations, in updating the one or more configurations, processor 412 may update the one or more configurations to reserve one or more subsets of PRBs for the SRS, one or more subsets of PRBs for one or more legacy UL channels, or a combination thereof. Alternatively, or additionally, in updating the one or more configurations, processor 412 may update the one or more configurations to restrict one or more PUCCH resources or one or more PUSCH resources from being used for one or more legacy UL channels.

### Illustrative Processes

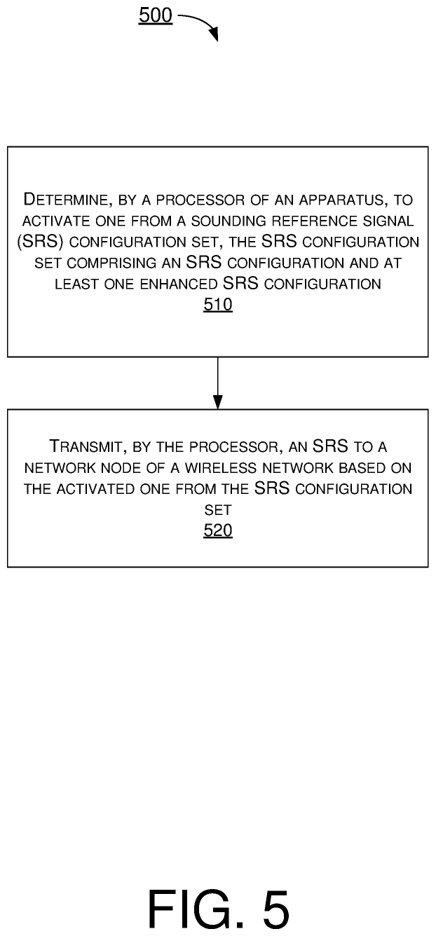

FIG. 5 illustrates an example process 500 in accordance with an implementation of the present disclosure. Process 500 may be an example implementation of the proposed schemes described above with respect to enhancement of SRS in mobile communications in accordance with the present disclosure. Process 500 may represent an aspect of implementation of features of apparatus 410 and apparatus 420. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may also be repeated partially or entirely. Process 500 may be implemented by apparatus 410, apparatus 420 and/or any suitable wireless communication device, UE, RSU, base station or machine type devices. Solely for illustrative purposes and without limitation, process 500 is described below in the context of apparatus 410 as UE 110 and apparatus 420 as network node 125. Process 500 may begin at block 510.

At 510, process 500 may involve processor 412 of apparatus 410 determining to activate one from an SRS configuration set that comprises an SRS configuration and at least one enhanced SRS configuration. Process 500 may proceed from 510 to 520.

At 520, process 500 may involve processor 412 transmitting, via transceiver 416, an SRS to apparatus 420 as a network node (e.g., network node 125) of a wireless network (e.g., wireless network 120) based on the activated one from the SRS configuration set.

In some implementations, the SRS configuration set may further comprise an updated configuration for an UL channel to apparatus 410. In some implementations, the at least one enhanced SRS configuration may include one or more of the following: (i) information related to a starting SC-FDMA symbol index in an UL subframe for the SRS; (ii) information related to a number of one or more SC-FDMA symbols in the UL subframe for the SRS; (iii) information related to an SRS periodicity; (iv) information related to an SRS offset; (v) information related to an SRS hopping pattern; and (vi) information related to generation of an SRS sequence.

In some implementations, process 500 may involve processor 412 performing additional operations. For instance, process 500 may involve processor 412 receiving, via transceiver 416, an RRC signaling from apparatus 420 that configures the SRS configuration prior to the determining, the activating and the transmitting.

In some implementations, process 500 may involve processor 412 performing additional operations. For instance, process 500 may involve processor 412 updating one or more configurations for one or more UL channels to generate the updated configuration.

In some implementations, in updating the one or more configurations, process 500 may involve processor 412 updating the one or more configurations to reserve one or more subsets of PRBs for the SRS, one or more subsets of PRBs for one or more legacy UL channels, or a combination thereof. Alternatively, or additionally, in updating the one or more configurations, process 500 may involve processor 412 updating the one or more configurations to restrict one or more PUCCH resources or one or more PUSCH resources from being used for one or more legacy UL channels.

In some implementations, process 500 may further involve processor 412 receiving a layer 1 (L1) signaling and, in response, activating the one from the SRS configuration set. Alternatively, process 500 may further involve processor 412 receiving a MAC CE and, in response, activating the one from the SRS configuration set. Alternatively, process 500 may further involve processor 412 activating the one form the SRS configuration set based on a predefined rule.

In some implementations, the predefined rule may include activating a default SRS configuration at a beginning of the SRS configuration set comprising at least one SRS configuration and at least one enhanced SRS configuration. In some implementations, the predefined rule may include activating a new or default SRS configuration after expiry of a timer. Alternatively, or additionally, the predefined rule may include deactivating a current SRS configuration after expiry of a timer. Alternatively, or additionally, the predefined rule may include activating a new or default SRS configuration and deactivating a current SRS configuration.

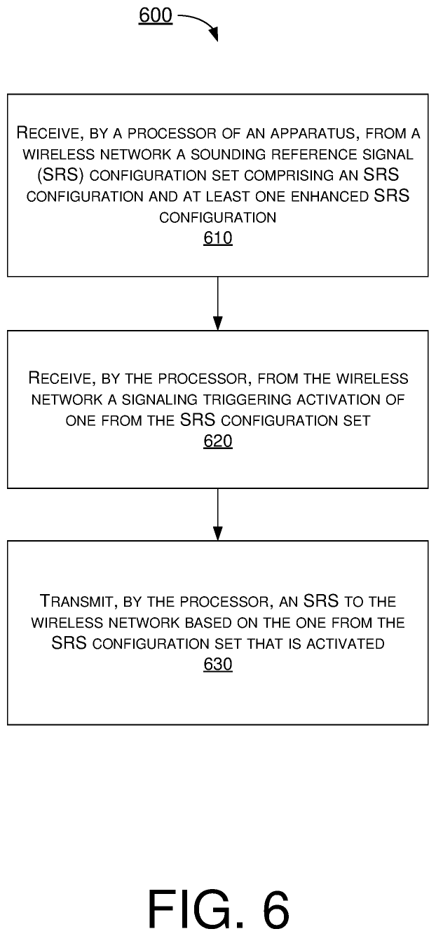

FIG. 6 illustrates an example process 600 in accordance with an implementation of the present disclosure. Process 600 may be an example implementation of the proposed schemes described above with respect to enhancement of SRS in mobile communications in accordance with the present disclosure. Process 600 may represent an aspect of implementation of features of apparatus 410 and apparatus 420. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may also be repeated partially or entirely. Process 600 may be implemented by apparatus 410, apparatus 420 and/or any suitable wireless communication device, UE, RSU, base station or machine type devices. Solely for illustrative purposes and without limitation, process 600 is described below in the context of apparatus 410 as UE 110 and apparatus 420 as network node 125. Process 600 may begin at block 610.

At 610, process 600 may involve processor 412 of apparatus 410 receiving, via transceiver 416, from a wireless network (e.g., wireless network 120) via apparatus 420 as a network node (e.g., network node 125) an SRS configuration set comprising an SRS configuration and at least one enhanced SRS configuration. Process 600 may proceed from 610 to 620.

At 620, process 600 may involve processor 412 receiving, via transceiver 416, from the wireless network a signaling triggering activation of one from the SRS configuration set. Process 600 may proceed from 620 to 630.

At 630, process 600 may involve processor 412 transmitting, via transceiver 416, an SRS to the wireless network based on the one from the SRS configuration set that is activated.

In some implementations, the at least one enhanced SRS configuration may include one or more of the following: (i) information related to a starting SC-FDMA symbol index in an UL subframe for the SRS; (ii) information related to a number of one or more SC-FDMA symbols in the UL subframe for the SRS; (iii) information related to an SRS periodicity; (iv) information related to an SRS offset; (v) information related to an SRS hopping pattern; and (vi) information related to generation of an SRS sequence.

In some implementations, in receiving the signaling, process 600 may involve processor 412 receiving a DCI signaling, a MAC CE, or an RRC reconfiguration signaling.

In some implementations, process 600 may involve processor 412 performing additional operations. For instance, process 600 may involve processor 412 updating one or more of the plurality of configurations for one or more UL channels to generate the updated configuration. In some implementations, in updating the one or more configurations, process 600 may involve processor 412 updating the one or more configurations to reserve one or more subsets of PRBs for the SRS, one or more subsets of PRBs for one or more legacy UL channels, or a combination thereof. Alternatively, or additionally, in updating the one or more configurations, process 600 may involve processor 412 updating the one or more configurations to restrict one or more PUCCH resources or one or more PUSCH resources from being used for one or more legacy UL channels.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, to activate one from a sounding reference signal (SRS) configuration set, the SRS configuration set comprising an SRS configuration and at least one enhanced SRS configuration; and
transmitting, by the processor, an SRS to a network node of a wireless network based on the activated one from the SRS configuration set.

2. The method of claim 1, wherein the SRS configuration set further comprises an updated configuration for an uplink (UL) channel to the apparatus.

3. The method of claim 2, wherein the at least one enhanced SRS configuration comprises one or more of:
information related to a starting single-carrier frequency-division multiple access (SC-FDMA) symbol index in an uplink (UL) subframe for the SRS;
information related to a number of one or more SC-FDMA symbols in the UL subframe for the SRS;
information related to an SRS periodicity;
information related to an SRS offset;
information related to an SRS hopping pattern; and
information related to generation of an SRS sequence.

4. The method of claim 1, further comprising:
receiving, by the processor, a radio resource control (RRC) signaling from the network node that configures the SRS configuration.

5. The method of claim 2, further comprising:
updating, by the processor, one or more configurations for one or more uplink (UL) channels to generate the updated configuration.

6. The method of claim 5, wherein the updating of the one or more configurations comprises updating the one or more configurations to reserve one or more subsets of physical resource blocks (PRBs) for the SRS, one or more subsets of PRBs for one or more legacy UL channels, or a combination thereof.

7. The method of claim 5, wherein the updating of the one or more configurations comprises updating the one or more configurations to restrict one or more physical uplink control channel (PUCCH) resources or one or more physical uplink shared channel (PUSCH) resources from being used for one or more legacy UL channels.

8. The method of claim 1, further comprising:
receiving, by the processor, a layer 1 (L1) signaling from the network node; and
activating, by the processor, the one from the SRS configuration set responsive to receiving the L1 signaling.

9. The method of claim 1, further comprising:
receiving, by the processor, a medium access control (MAC) control element (CE) from the network node; and
activating, by the processor, the one from the SRS configuration set responsive to receiving the MAC CE.

10. The method of claim 1, further comprising:
activating, by the processor, the one from the SRS configuration set based on a predefined rule.

11. The method of claim 10, wherein the predefined rule comprises activating a default SRS configuration at a beginning of configuring the SRS configuration set comprising at least one SRS configuration and at least one enhanced SRS configuration.

12. The method of claim 10, wherein the predefined rule comprises activating a new or default SRS configuration after expiry of a timer.

13. The method of claim 10, wherein the predefined rule comprises deactivating a current SRS configuration after expiry of a timer.

14. The method of claim 10, wherein the predefined rule comprises activating a new or default SRS configuration and deactivating a current SRS configuration.

15. A method, comprising:
receiving, by a processor of an apparatus, from a wireless network a sounding reference signal (SRS) configuration set comprising an SRS configuration and at least one enhanced SRS configuration;
receiving, by the processor, from the wireless network a signaling triggering activation of one from the SRS configuration set; and
transmitting, by the processor, an SRS to the wireless network based on the one from the SRS configuration set that is activated.

16. The method of claim 15, wherein the at least one enhanced SRS configuration comprises one or more of:
information related to a starting single-carrier frequency-division multiple access (SC-FDMA) symbol index in an uplink (UL) subframe for the SRS;
information related to a number of one or more SC-FDMA symbols in the UL subframe for the SRS;
information related to an SRS periodicity;
information related to an SRS offset;
information related to an SRS hopping pattern; and
information related to generation of an SRS sequence.

17. The method of claim 15, wherein the receiving of the signaling comprises receiving a downlink control information (DCI) signaling, a medium access control (MAC) control element (CE), or a radio resource control (RRC) reconfiguration signaling.

18. The method of claim 15, further comprising:
updating, by the processor, one or more of the plurality of configurations for one or more uplink (UL) channels to generate the updated configuration.

19. The method of claim 18, wherein the updating of the one or more configurations comprises updating the one or more configurations to reserve one or more subsets of physical resource blocks (PRBs) for the SRS, one or more subsets of PRBs for one or more legacy UL channels, or a combination thereof.

20. The method of claim 18, wherein the updating of the one or more configurations comprises updating the one or more configurations to restrict one or more physical uplink control channel (PUCCH) resources or one or more physical uplink shared channel (PUSCH) resources from being used for one or more legacy UL channels.
